(19) United States
(12) Patent Application Publication
(10) Pub. No.: US 2014/0261189 A1
(43) Pub. Date: Sep. 18, 2014

(54) AUTOMATED MONITORING OF COMPLIANCE IN AN EGG FARM BASED ON EGG COUNTS

(71) Applicant: Mitchell Barry Chait, Las Vegas, NV (US)

(72) Inventor: Mitchell Barry Chait, Las Vegas, NV (US)

(21) Appl. No.: 13/837,507

(22) Filed: Mar. 15, 2013

(51) Int. Cl. A01K 45/00

(52) U.S. Cl. CPC A01K 45/00
USPC 119/6.8

(57) ABSTRACT

Techniques for automatically monitoring and analyzing compliance of an egg farm based, at least in part, on egg count data. Sensors are configured to collect various data, including egg count data, throughout an egg farm. A rules engine correlates the egg count data with other types of data collected from the sensors, and analyzes the data to determine a compliance status of hens and/or eggs. The rules engine may analyze the collected data by estimating a current and/or future status of compliance. The rules engine may compare the estimated and/or predicted compliance status with one or more rules to determine whether action should be taken. Based on the analysis, the rules engine may generate location alerts and/or instructions regarding potential non-compliance. The alerts and/or instructions may be provided to one or more reporting devices.

### BACKGROUND

The commercial egg production industry relies on facilities, called egg farms, to produce and package eggs. Egg farms typically have one or more hen houses, which can be multileveled buildings with long rows of special housing units, called battery cages, that each house one or more hens. In some egg farms, called cage-free or free-range farms, the hens are allowed to roam freely inside a building or outside in open air. Many egg farms utilize mechanical transportation mechanisms to automatically collect and package eggs. For example, some egg farms have various egg transporting mechanisms that transport eggs from egg laying hens to processing operations, such as washing, grading, and packaging. Such automated egg collection and packaging mechanisms have enabled egg farms to scale to large dimensions, capable of housing up to hundreds of thousands of egg-laying hens.

Egg farms are typically required to follow rules and/or standards established by various entities, such as government, industry, and/or companies. Such standards typically involve the safety and quality of the eggs that are produced by the farm and distributed to consumers. For example, governmental food safety regulations typically require egg farms to maintain a clean and healthy environment for eggs and the egg laying hens. Unhealthy hens may produce eggs that are of low quality or even harmful to consumers. For example, unhealthy hens may consistently produce low grade eggs, leading to low profitability for the egg farm. Unhealthy hens can also cause spread of disease, within the hen house and/or in the consumer market. For example, unhealthy hens can lead to higher hen mortality, and the deceased hens can contribute to infectious disease environments (e.g., due to pests, such as flies or rodents), causing other hens to become unhealthy and potentially produce infected eggs that are passed on to consumers.

### SUMMARY

Consistent and proper inspection of egg-laying hens and their eggs can help ensure the safety, quality, efficiency, and productivity of the consumer egg industry. Prompt detection and handling of unhealthy hens and/or non-compliant eggs may mitigate the spread of disease, both in egg-laying hens and in human consumers of those eggs. In order to provide such detection and handling, traditional hen houses typically rely on human workers to physically inspect up to thousands of hen cages, sometimes in dangerous and unsanitary conditions.

However, such labor-intensive human inspection can be unsafe, inefficient, and prone to errors and/or fraud. Human inspection is typically limited in its ability to accurately detect unhealthy hens amongst potentially hundreds of thousands of hens that populate what are often dark and cramped conditions in a hen house. Without prompt and proper detection and handling of unhealthy and/or deceased hens, a hen house may pose a danger to egg-laying hens, workers, and human consumers.

In traditional egg farms, eggs are typically monitored and counted in aggregate, during grading or packaging, without regard for the potential implications on the health of the hens that laid the eggs. The inventors have recognized and appreciated that, in some embodiments, by monitoring and counting egg-count data at different points in an egg farm, with different granularity, such data may provide valuable insight into the health and behavior of one or more egg-laying hens, as well as the quality of the eggs passed on to consumers.

The inventors have recognized and appreciated that significant improvements in the efficiency, safety, and costs of the egg production industry may be achieved by a system that automatically monitors and analyzes, in a real-time manner, the number of eggs produced in an egg farm, relative to the number of egg-laying hens. In some embodiments, one or more sensors may be distributed throughout an egg farm and configured to collect data related to the number of eggs produced by one or more hens. In some embodiments, sensors may also collect other types of data, such as data related to human workers, machines, operations, or any other suitable aspect of an egg farm that may have an impact on the health of hens and quality of eggs.

The inventors have recognized and appreciated techniques to determine whether an egg count indicates a non-compliant, or potentially non-compliant, state within the egg farm. For example, in some embodiments, the system may determine that an undercount of eggs indicates potentially unhealthy hens. For example, the system may adaptively learn the egg-laying behavior of hens and detect deviations that indicate abnormal behavior. Additionally or alternatively, in some embodiments, the system may determine that an overcount of eggs indicates that eggs from outside unverified sources have been introduced into the egg farm. For example, such alien eggs may have bypassed quality-control standards required of eggs that are native to the egg farm.

The inventors have also recognized and appreciated that various types of data, including data related to human behavior, may be analyzed in combination with egg count data, to more accurately determine compliance of the egg farm. Such an automated system may enable real-time monitoring of compliance in the egg farm, without necessarily relying on potentially erroneous and/or fraudulent human labor to inspect thousands of eggs and hens.

One embodiment is directed to a system for monitoring an egg farm, the system comprising an egg detection device configured to detect eggs, a transmitter configured to transmit egg count information indicating a number of eggs detected by the egg detection device; and a computing device configured to execute at least one algorithm that analyzes the egg count information and determines a compliance status.

Another embodiment is directed to a method of monitoring an egg farm, the method comprising detecting at least one egg using an egg detection device, transmitting egg count information indicating a number of eggs detected by the egg detection device, and using at least one processor to execute at least one algorithm that analyzes the egg count information and to determine a compliance status.

Another embodiment is directed to at least one computer-readable medium having stored thereon computer-readable program instructions which, when executed by at least one processor, perform acts of detecting at least one egg using an egg detection device, transmitting egg count information indicating a number of eggs detected by the egg detection device, and analyzing the egg count information to determine a compliance status.

Another embodiment is directed to a system configured to monitor, manage, and instrument compliance in a distributed work environment. The system comprises at least one input configured to receive data comprising egg count information and secondary information. The secondary information is related to one or more of: behavior of one or more persons responsible for taking action in the distributed work environment; biological or environmental parameters associated with the distributed work environment; operational conditions and/or events; apparatus usage and/or condition; at least one standard and degree of compliance therewith; or product production and/or delivery logistics. The system also comprises a data store configured to store the data, and at least one processor configured to execute stored program instructions to process at least part of the data and determine, based on the processing of at least part of the data, a compliance status.

It should be appreciated that all combinations of the foregoing concepts and additional concepts discussed in greater detail below (provided that such concepts are not mutually inconsistent) are contemplated as being part of the inventive subject matter disclosed herein.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic illustration of an example of a system of automated monitoring and reporting of compliance in an egg farm in which some embodiments may be implemented;

FIG. 2 is a schematic illustration of an example of an egg farm environment in which a system of automated monitoring and reporting of compliance may be used, in accordance with some embodiments;

FIG. 3 is a schematic illustration of an example of a data store configured to store information including sensor data and rules, in accordance with some embodiments;

FIG. 4 is a flow chart of an example of processing performed by a system of automated monitoring and reporting of compliance in an egg farm, in accordance with some embodiments;

FIG. 5 is a flow chart of an example of processing performed by a rules engine in a system of automated monitoring and reporting of compliance in an egg farm, in accordance with some embodiments; and

FIG. 6 is an example of a computing system on which some embodiments may be implemented.

### DETAILED DESCRIPTION

The inventors have recognized and appreciated that potentially hazardous conditions in the consumer egg industry may be more quickly and accurately detected by a system that, in real-time, automatically monitors, analyzes, and provides feedback on the egg-laying performance of hens. Such a system may adaptively and dynamically learn the egg-laying behavior of one or more hens, by analyzing data collected from one or more types of sensors distributed throughout an egg farm. In some embodiments, the system may then use a dynamically adaptive rules engines to analyze egg count data and determine whether unsafe, or potentially unsafe, conditions exist for hens, workers, and consumers.

A typical egg farm is often subject to different sets of requirements related to safety and quality of eggs. Such requirements may be set by various entities, such as governmental, industrial, or corporate. For example, safety standards typically require an egg farm to maintain a healthy environment for egg-laying hens, by removing sick or dead hens promptly to avoid spread of disease. As another example, egg farms are typically prohibited from introducing foreign eggs from lower-quality sources to supplement their egg yields, as such eggs may not undergo the same rigorous inspection as eggs that are native to the farm. Ensuring compliance with such requirements can be a challenging task, especially for large egg farms that produce thousands of eggs from thousands of hens every day. Using human workers to manually verify compliance with various standards and rules can be costly, inefficient, and prone to errors and/or fraud.

The inventors have recognized and appreciated that significant advances in the efficiency and safety of eggs and egg farms may be achieved by a system that automatically monitors compliance of an egg farm with one or more standards and rules, by monitoring and analyzing egg count data. In some embodiments, when the analyzed data of egg counts indicates non-compliance with a set of prescribed rules, the system may display alerts and/or instructions regarding the non-compliance, and/or take actions to resolve the non-compliance.

In some embodiments, non-compliance may be related to one or more potentially unhealthy hens. For example, the system may determine that an abnormally small egg count indicates potentially unhealthy or deceased hens. The system may then issue alerts/instructions indicating where to locate and/or how to handle the potentially unhealthy hens. In egg farms in which spread of disease amongst hens is a concern, real-time alerts may be desirable to promptly locate and remove unhealthy or deceased hens.

Additionally or alternatively, the non-compliance may be related to potentially non-compliant quality of eggs. For example, the system may determine that an abnormally large egg count indicates potential intrusion of eggs from a foreign environment. Such eggs may not have gone through required quality-control processes, and may be of lower quality than the required standards for the egg farm. The system may then issue alerts/instructions indicating that the entire egg farm may be non-compliant and/or perform further detection and processing to determine any potentially foreign eggs.

It should be appreciated, however, that embodiments are not limited to these two examples of using egg-count data to determine compliance in an egg farm, as any suitable notion of compliance in an egg farm may be determined using egg count data.

In some embodiments, different types of sensors may be used to collect a variety of data throughout the egg farm. Some sensors may be configured to collect data directly related to a number of eggs produced by one or more hens. In some embodiments, sensors may also be configured to collect data indirectly related to egg laying, such as ambient conditions in the environment of the egg laying hens. The data collected by the sensors may be correlated and analyzed by one or more processor-implemented algorithms that apply a suitable inference and/or estimation rule to determine a compliance status of one or more hens and/or their eggs.

The inventors have recognized and appreciated that by collecting and analyzing a wide variety of data, such data may be used to more accurately predict whether an egg count indicates non-compliance by the egg farm. For example, the system may correlate different types of data regarding the same group of hens/eggs to improve redundancy and reliability of determining potential non-compliance. The system may, in some embodiments, perform predictive analysis to enable proactive detection of conditions of non-compliance, and may suggest appropriate actions to mitigate such non-compliance.

Based on the analysis of the data collected by sensors, in some embodiments, one or more reporting devices may issue instructions and/or alerts indicating the location of potentially non-compliant hens and/or eggs. The reporting devices may be used, for example, by a supervisor, workers, or other suitable entity, who may then be notified of a number and/or location of the non-compliant hens and/or eggs. The reporting devices may be communicative with the server(s) via a communication link or network, and may be local to or remote from the egg farm. It should be appreciated, however, that separate reporting devices are optional, as indications and/or alerts may be generated on any suitable computing device(s). As non-limiting examples, indications and/or alerts may be generated on the computing device(s) processing the collected data, on the one or more sensors themselves (e.g., using visible alerts, audible alarms, etc.), or on any other suitable device, whether local or remote to the egg farm.

The inventors have recognized and appreciated that such an automated egg-count monitoring and reporting system may enable efficient, accurate, and proactive detection of non-compliance in an egg farm. In large egg farms with potentially hundreds of thousands of hens and eggs, such an automated and intelligent system may mitigate difficulties in ensuring the safety of hens and the quality of their eggs. For example, such an automated monitoring and reporting system may reduce the need for human workers to manually check hundreds of thousands of cages or nest boxes and enter potentially unsafe conditions.

In some embodiments, the system may also be used in conjunction with human monitoring, and may reduce inaccuracies and/or fraud in the monitoring of compliance in the egg farm. By correlating different types of data to determine an overall estimation and/or prediction of compliance in the egg farm, the system may more accurately identify and resolve existing or potential non-compliances in the egg farm. The inventors have recognized and appreciated that such a system may improve efficiency, safety (for workers, hens, and consumers), and reduce costs in the egg industry.

In some embodiments, the system may be provided with, or may dynamically learn, the egg-laying behavior of one or more hens. For example, the system may be provided with an average number of eggs laid by a typical hen, which may be determined based on a sample population of hens or based on data from individual hens. The system may also be provided with additional statistical information, such as correlations between number of eggs laid and one or more other factors (e.g., type of hen, location of the hen, ambient conditions in the environment such as temperature or light, etc.).

As another example, specific historical egg-laying data particular to the hen(s) may be collected and recorded, and analyzed to detect anomalies in the detected data. For example, if a particular hen has historically produced a small number of eggs, then a small count of eggs in a particular time period may not necessarily indicate an unhealthy condition for that hen. As another example, if a group of hens historically produces a large number of eggs during a particular time of year, then an abnormally high egg count over a similar period of time may not necessarily indicate intrusion of foreign eggs into the egg farm. In such a scenario, the system may collect more detailed or refined egg-count information to narrow down a particular batch of eggs and/or group of hens that may account for the abnormally high egg count.

The number of eggs may be detected in a variety of ways, using any suitable egg-counting sensor. In some embodiments, egg-counting sensors may be configured to directly detect the presence of an egg laid by a hen or group of hens, using a suitable technique. For example, egg-counting sensors may detect eggs as they roll off battery cages onto conveyer belts. In some embodiments, the sensors may be tactile sensors that use light springs or other actuated mechanisms to detect a passing egg, or the sensors may be infrared or optical sensors that remotely detect motion of a passing egg, or the sensors may be weight-bearing sensors that detect the weight of any eggs, which may then be used to estimate a number of eggs, just to name a few non-limiting examples.

It should be appreciated, however, that embodiments are not limited to any particular type or number of egg-count sensors, as any suitable sensor may be configured to collect any suitable data related to a number of eggs. The data may be used, in any suitable way, to determine a compliance status of the egg farm. Though, it should be appreciated that any number of processing steps may be used in determining the compliance status based on the collected sensor data. For example, in some embodiments, a two-step inference process may be used, whereby the collected data (e.g., weight of eggs) may be used to infer a number of eggs, and then the estimated number of eggs may be used to infer a compliance status.

In some embodiments, different types of data may be collected by different types of sensors, and the data may be cross-correlated by the system. Such cross-correlation of different data, though entirely optional, may enable the system to more accurately analyze a compliance status. As such, the system may be able to improve reliability by using different sources of data to confirm and verify sources, or potential sources, of non-compliance. This may not only improve detection of non-compliance, but may also reduce the number of “false alarms” by verifying and double-checking detected sources of non-compliances before issuing alerts/instructions.

For example, if egg-count data detected by egg-count sensors is abnormally low for a particular group of hens, then the system may subsequently acquire and process additional data collected by environmental sensors around that group of hens. If the environmental sensors detect an abnormal condition in the environment (e.g., low temperature, low lighting, etc.), then the system may determine that an abnormality exists in the environment, rather than in the hens themselves. The system may then recommend that the environmental condition be modified (e.g., by raising the temperature, increasing the lighting, etc.). If, after modifying the environmental condition, the egg count is still abnormally low, then the system may issue instructions for a human worker to inspect the hens. Though this was merely one non-limiting example, an automated egg-count system may generally use any number and types of sensors to detect ambient conditions related to egg-laying, to enable an egg farm to make more informed and accurate decisions regarding compliance of hens and their eggs.

The system may comprise a number of sensors, which may communicate with one or more computing devices that collect and process data collected by the sensors. In some embodiments, the processing of data may be implemented in a centralized server. Though, it should be appreciated that embodiments are not limited to a centralized server, as data processing may be performed by one or more computing devices, such as personal computers or mobile devices, that may be distributed throughout the egg farm.

In embodiments in which servers are used, one or more servers may implement algorithms that correlate and analyze the collected data based on a set of rules or specifications. The servers may have access to one or more data stores that store data, including the collected data, data processed from the collected data, and/or the rules or specifications. In some embodiments, the servers may generate alerts or remediation instructions to one or more devices, such as reporting devices or the sensors, based on the analysis of the collected data. In some embodiments, the servers may also communicate back to the sensors, to reconfigure and/or adapt the sensors based on collected data and analysis.

The inventors have recognized and appreciated that an automated egg-count monitoring and reporting system may be useful in a wide variety of egg farms, not limited to those with battery cages. As non-limiting examples, the system may be used in free-range farms, where sensors may be configured to detect eggs in nest boxes, in an open field, or at any suitable collection point. Regardless of the exact nature of the egg farm, a system that automatically monitors egg-count, using one or more sensors, and determines compliance of the egg farm based on the egg-count using suitable estimation and/or prediction algorithms, may improve the efficiency and safety of egg production.

An automated monitoring and reporting system may reduce the need for workers to manually check potentially unsafe and unsanitary conditions to inspect hens and eggs. In some embodiments, the system may also be used in conjunction with human monitoring, and may reduce inaccuracies and/or fraud in the monitoring of hens and eggs.

In some embodiments, the inventors have recognized and appreciated that the system may enable proactive management of workers. For example, different workers may be monitored while performing particular tasks to determine whether they are performing the tasks pursuant to a set of instructions and/or standards. The system may be able to automatically detect error and/or fraud by correlating human behavioral data with other types of sensor data. As a non-limiting example, if a worker tries to manipulate machine records in a manner that is inconsistent with data collected by human behavioral sensors and/or machine sensors, then the system may detect the non-compliance and alert an appropriate person or entity.

The inventors have recognized and appreciated that such a system may mitigate difficulties in controlling a multitude of workers and/or entities in a distributed work environment. In some embodiments, the system may be provided with, or may dynamically learn, the tasks assigned to different workers and, based on collected data, may dynamically learn the capabilities of the workers. The inventors have recognized and appreciated that such a system may improve efficiency and productivity by enabling improved coordination and allocation of resources among different workers and/or entities, providing faster and more accurate decision-making and responses to problems.

In some embodiments, human behavioral data may be correlated with other types of data to detect patterns of inconsistency, error, and/or fraud that may indicate non-compliance with instructions or standards. In some embodiments, the standards may comprise rules and/or instructions provided by a suitable entity, such as a governmental agency, an industry group, and/or a specific company. The system analyze and correlate data collected from potentially diverse sensors. Such an integrated system may enable monitoring and management of operations throughout the egg farm. It should be appreciated, however, that embodiments are not limited to any particular type of collected data and standards, as any suitable data and standards may be used as a basis for determining compliance.

Distributed work environments, such as egg farms, may have a large number of interrelating workers and machines. Advances in sensing and communication technology have enabled a variety of different types of information to be collected. However, it may be a challenge to transform the huge amounts of data into effective decision-making, especially when some data may be incomplete or have errors. Furthermore, in some embodiments, acquiring measurements may be costly. Energy is often a limited resource and may be consumed by communication, sensing, and computation. Measurements may not be equally useful and/or may incur different resource expenditures. In some embodiments, a sensor management algorithm may determine which sensors to activate at each time to achieve a desired trade-off between management performance and communication cost.

The sensors may be configured to collect different types of data, such as human behavioral data, biological data, environmental data, and/or machine data. It should be appreciated that embodiments are not limited in the type of sensors used, as different types of data collected by different types of sensors may be correlated and analyzed by the system. The analysis may be performed by a rules engine, which implements one or more algorithms that analyze the collected data according to the specified instructions and/or standards to detect non-compliance. In some embodiments, reporting devices may be carried by workers and/or supervisors and may provide real time alerts, recommendations, and/or instructions based on the analysis by the rules engine.

FIG. 1 is a schematic illustration of an example of an automated egg-count monitoring and reporting system, according to some embodiments. In some embodiments, the system 100 may be used to monitor and analyze data collected from different sensors distributed throughout an egg farm, and report results of the analysis to one or more reporting devices. Though, it should be appreciated that embodiments are not limited to any particular number of sensors nor the use of reporting devices.

In some embodiments, system 100 may comprise a server 102 that implements a rules engine 104 and a data store 106 that stores collected data and/or predefined specifications. In some embodiments, the server 102 may be a centralized server that aggregates and processes all the aggregated data, although it should be appreciated that embodiments are not limited to a single centralized server, and may implement the rules engine 104 and the data store 106 in a plurality of computing devices that may be distributed throughout the system 100.

Regardless of how the server 102 is implemented, it may be connected to one or more devices that route and/or forward information to or from the server 102. As non-limiting examples, FIG. 1 illustrates a wireless access point 108a and a router 108b that connects the server 102 with a plurality of sensors, for example, sensors 110a, 110b, and 112. The sensors 110a, 110b, 112 may be any suitable type of sensors that are adapted to collect data from their environments. Though three sensors are shown in FIG. 1, it should be appreciated that the exact number and types of sensors is not limiting.

In some embodiments, one or more sensors, such as sensors 110a and 110b, may be used to collect data related to egg-laying behavior of hens. Egg-count sensors 110a and 110b may count eggs using any suitable technique. In some embodiments, tactile egg-count sensors may use, for example, an actuated mechanism, such as mechanical fingers attached to a light spring or sponge, or a weight-bearing mechanism, to physically detect the presence of eggs. In some embodiments, remote egg-count sensors may include, for example, infrared sensors or cameras that detect motion and/or presence of eggs. Egg-counting sensors may be placed at different parts of an egg farm to monitor a number of eggs laid by a hen or group of hens.

Alternatively, or additionally, other types of sensors may be used that collect data that may not be directly related to egg counts, such as secondary sensor 112. For example, secondary sensor 112 may be, in some embodiments, an environmental sensor that collects data related to ambient conditions around the hens. As another example, secondary sensor 112 may be a sensor that monitors the hens themselves, either via sensors attached to the hens or remote from the hens. As yet another example, secondary sensor 112 may be a human data sensor that detects data related to human workers, who may be responsible for monitoring hens. Human sensor may be wearable, such as modified ID badges, or personal digital assistants (PDAs). Sensors monitoring the hens or humans may use any suitable technology, including, but not limited to, Radio Frequency Identification (RFID) tags, Global Positioning System (GPS) chips, microphones, cameras, accelerometers, to detect any physical behavior relevant to monitoring the egg-laying behavior and health status of hens.

It should be appreciated, however, that embodiments are not limited to a particular nature of data collected, nor sensors used, as the system 100 may utilize, monitor, and analyze any suitable data relevant to the health and egg-laying of hens. As non-limiting examples, in some embodiments, sensors may be configured to collect machine data or operational data related to processing or handling of eggs. In some embodiments, the sensors 110a, 110b, and 112 may be distributed in different geographic locations in the egg farm, or may be within a common geographic location and/or monitor the same hen or group of hens.

In some embodiments, in addition to collecting data, sensors may perform processing on data collected and/or instructions received. For example, in some embodiments, sensors may perform compression on data that is collected, using techniques in compressive sensing. Such compression may enable a more compact representation of the collected data to be transmitted, thus conserving communication resources. Additionally or alternatively, compression may be performed by intermediate devices, such as a wireless access point (WAP) 108a and/or router 108b. It should be appreciated, though, that embodiments are not limited to compressive sensing, and that data may be transmitted from the sensors 110a, 110b, 112 to the server 102 in the same form in which they are sensed.

In some embodiments, one or more sensors may communicate with each other. The example in FIG. 1 illustrates egg-counting sensor 110a and secondary sensor 112 communicating via communication link 114, which may be any suitable communication medium, such as wired or wireless. The information transmitted between the sensors 110a and 112 may be, for example, related to the data collected by the sensors and/or may be related to specifications sent from the server 102. In some embodiments, inter-sensor links may be used to relay information from one sensor to another, for example, to perform peer-to-peer routing between sensors that may not otherwise be directly connected to any other access point to the server 102. Additionally, or alternatively, the communication link 114 may be used to enable cooperation between sensors 110a and 112 to help improve the accuracy of data collection, for example, by cross-correlating data collected and verifying consistency.

In some embodiments, the sensors may be specifically configured to collect data that is most relevant to determining the health and egg-laying behavior of hens. In some embodiments, the sensors may be dynamically adjusted in real time based on the collected and analyzed data. For example, a particular sensor may be adapted to collect more and/or different data when a non-compliance is detected in the data collected by that sensor. In some embodiments, such adjustments may be made by the server 102, or by any other computing device that has access to the data collected by the sensor. In some embodiments, sensors may also have an input/output interface, such as a keyboard or a screen, to enable manual control of the sensor.

Regardless of the exact nature of the sensors 110a, 110b, and 112, and the techniques by which they communicate with the server 102 and/or each other, the sensors 110a, 110b, and 112 may collect and transmit data to the server 102 for analysis using the rules engine 104 and storage in the data store 106. The server 102 may be configured to recognize data collected from different sensors, and analyze the different types of data using the appropriate specifications applied by the rules engine 104. As such, in some embodiments, the system 100 may be able to monitor and analyze the egg-laying behavior and health of hens throughout an egg farm.

In some embodiments, the collected data may be stored in a computer memory, such as a data store 106. The data store 106 may be integrated with the server 102 or may comprise multiple memory locations distributed in different parts of a network. The stored data may include any of the data described above, or any other suitable type of data collected by sensors and/or relevant to processing the data collected by sensors. In some embodiments, the data store 106 may store data, either historical or statistical, for individual hens or may store aggregated data for groups of hens. Specifications may include, as non-limiting examples, statistical information for a population of hens or standards established by a suitable entity, such as the government, industry, or company. In some embodiments, the data store 106 may be accessible by one or more other computing devices, such as by the sensors 110a, 110b, and 112.

In some embodiments, the system 100 may implement the rules engine 104 configured to aggregate and analyze the different types of collected data and determine an appropriate course of action. In some embodiments, the rules engine 104 may be able to learn and make decisions in real time. As a non-limiting example, the rules engine 104 may analyze egg-count data and estimate a health status of the hen(s) that are related to the egg count data, to determine whether or not to assign a worker to manual check the hen(s). In some embodiments, the system may predict a potential future health status of the hen(s) to proactively manage the conditions of the egg farm. Such estimations and/or predictions may be made, for example, by a suitable machine learning algorithms trained with past historical data from the hen(s) or environment around the hen(s), and/or neural networks or simulations.

Regardless of the exact nature of the algorithms implemented by the rules engine 104, the rules engine 104 may be able to determine a desired plan of action based on the different types of data collected by the sensors 110a, 110b, and 112. Determining a desired plan of action may be based on any suitable technique. As non-limiting examples, the rules engine 104 may perform linear/nonlinear optimization algorithms, dynamic programming, and/or Monte Carlo simulations to select one or more actions that should be performed to ensure a proper health status of hens.

In some embodiments, the rules engine 104 may be able to cross-correlate different types of data collected by different sensors 110a, 110b, and 112, some of which may be related to a common hen or group of hens. Some of the sensors 110a, 110b, or 112 may be located at a common location, or may be distributed at different locations. Regardless of the exact location of the sensors, the rules engine 104 may be able to integrate the different types of data collected by the sensors 110a, 110b, and 112 to detect non-compliance and/or inconsistencies related to the hens. For example, if some of the sensors 110a, 110b, or 112 collect egg counts and other sensors collect ambient conditions, then the rules engine 104 may be able to correlate the egg count data with the ambient condition data to estimate and/or predict whether a hen is healthy. In some embodiments, based on the analysis of the collected data, the rules engine 104 may be able to dynamically reconfigure one or more sensors 110a, 110b, or 112, for example, to collect more detailed or different types of data.

Regardless of the exact nature of the rules engine 104, different types of collected data may be analyzed and correlated with a set of specifications to determine non-compliance and/or potential non-compliance, and to provide remediation instructions and/or recommendations for future action. The results of the analysis may be provided to one or more devices, such as reporting devices 116a, 116b, 116c. Although three such reporting devices are illustrated in FIG. 1, it should be appreciated that embodiments are not limited to any particular number of reporting devices, and that the use of reporting devices is optional. In some embodiments, the results of the analysis by the rules engine 104 may be provided back to the sensors 110a, 110b, and 112, which may have a display or other output mechanism to provide information about the results of the rules engine 104 to an appropriate operator or supervisor.

In some embodiments, if reporting devices 116a-116c are used, then such reporting devices may be any suitable device configured to display information related to the analysis of the rules engine 104. For example, in some embodiments, reporting devices 116a-116c may include mobile devices, personal computers, or workstations. The reporting devices 116a-116c may be specially designed devices, or may be unmodified consumer devices, such as smartphones with downloaded applications, configured to display the results of the rules engine 104. In some embodiments, the reporting devices 116a-116c may have a dashboard display that allows a user to interact with the reporting devices 116a-116c. For example, the reporting devices 116a-116c may enable a user to provide feedback to the server 102 based on results of the rules engine 104. Such feedback may include, for example, specific actions or instructions that should be taken by one or more workers and/or machines, and/or requests for more data or different types of data to be collected by the sensors 110a, 110b, or 112. In some embodiments, the reporting devices 116a-116c may enable a user to input new or updated specifications to be applied by the rules engine 104.

Regardless of the exact nature or use of the reporting devices 116a-116c, a user operating such reporting devices may be provided with real time information regarding non-compliance and/or potential non-compliance in any desired group of hens. As such, the system 100 may provide an integrated real time monitoring and management capability for an egg farm, in which problems may be detected and mitigated proactively, potentially before they propagate to other parts of the egg farm. The heterogeneous nature of different sensors involved in the system 100 may be seamlessly integrated by the rules engine 104, which may be aware of the different relationships between the data and, in some embodiments, is able to learn behavior and trends of the egg-laying behavior or health of hens, to accurately predict potential sources of non-compliance before such problems manifest and/or grow.

Although examples of embodiments have been described in relation to a system that monitors and analyzes egg count to determine compliance with a set of standards, it should be appreciated that, in some embodiments, an egg-count monitoring system may be used as part of a larger system that monitors, analyzes, and generates alerts/instructions based on multiple data inputs, of which egg count may be just one. For example, an egg-count monitoring system may be used as part of an end-to-end compliance system for an egg supply chain, which monitors and analyzes data collected from sensors in different parts of the supply chain to detect and manage compliance with one or more rules, such as a cold chain requirement.

Regardless of whether an egg-count monitoring system is used as part of a larger system, the system may detect and analyze egg count data to determine and/or predict compliance with one or more rules related to quality of eggs and safety of hens in an egg farm.

As one possible example of an egg farm environment in which system 100 may be used, FIG. 2 illustrates a battery cage monitoring environment 200. Such a environment 200 may be in an egg farm where hens are housed in battery cages, from which eggs are collected and aggregated on conveyer belts. Hens may be housed in a row of battery cages and egg-laying can occur either in the cage itself or in separate egg-laying nest boxes. It should be appreciated, however, that battery cage farms are merely an illustrative example, as the system may be used in any suitable egg farm, such as a free range egg farm.

In some embodiments, a centralized server 102 may monitor and analyze data collected from one or more sensors. Though, it should be appreciated that embodiments are not limited to a single centralized server and may utilize multiple computing devices to monitor and analyze data. Regardless of the exact number and nature of computing devices that analyze and monitor data, a rules engine 104 and a data store 106 may be used to analyze and store various data collected throughout the egg farm, and to monitor compliance with one or more specifications related to egg-laying and compliance of the egg farm.

In the example of FIG. 2, a battery cage 202 is illustrated, which may house one or more hens. The battery cage 202 may, in some embodiments, have a slanted floor or be connected to a slanted portion, such as a ramp 204, that allows eggs laid by hens to roll towards a front of the battery cage 202 towards an aggregator, such as conveyer belt 206. Though, it should be appreciated, that embodiments are not limited to a particular structure of battery cages and egg collection from hens, as any suitable structure for housing hens and collecting eggs from hens may be used.

In some embodiments, eggs that are laid by hens, such as eggs 208a, 208b, and 208c, may be detected and/or counted by one or more sensors, such as egg-counting sensors 210a, 210b, and 210c. It should be appreciated, however, that any number of egg-counting sensors may be used in any suitable location of an egg farm, as embodiments are not limited in this regard. Furthermore, the type of egg-counting sensors is not limiting, as any suitable sensor that detects the presence of eggs may be used.

Some examples of egg-counting sensors include, but are not limited to: mechanical sensors that have a mechanical switch or trigger (e.g., coupled to actuator, transistor, etc.) such as a set of fingers that detect eggs as they pass/drop (e.g., based on a spring, sponge, rotating wheel, etc.); weight-based sensors that count eggs based on detected weight; vibrational sensors (e.g., triboelectric, seismic, and inertia-switch sensors); infrared detection sensors that detect motion of eggs (e.g., PIR motion detectors); optical detection sensors that captures video or image data and the data can be processed using any suitable pattern recognition or machine vision to count eggs (e.g., an algorithm may compare image with a reference image and counts the different pixels); or sensors based on reflection of transmitted energy (e.g., laser radar, ultrasonic, microwave radar).

In some embodiments, egg-counting sensors may be coupled to one or more other systems in the egg farm to facilitate egg sensing. For example, in some embodiments, an egg farm may have a timed illumination system configured to induce egg-laying in hens. In such scenarios, egg-counting sensors may be configured to capture images when the illumination system illuminates particular regions of the egg farm. Such a configuration may have numerous advantages, for example enabling sensors to conserve power by only collecting data when conditions in the egg farm are suitable for data collection.

FIG. 2 illustrates three types of egg-counting sensors, 210a-210c, though it should be appreciated that these are merely non-limiting examples. In some embodiments, an egg-counting sensor 210a may be a tactile sensor that detects an egg 208a via a mechanism, such as a finger, that is actuated when in contact with the egg. The finger may be attached to a light spring, though embodiments are not limited in this regard, as any suitable detection mechanism may be used by tactile sensor 210a, such as a sponge or rotating wheel. The tactile sensor 210a may be located at any suitable location relative to the battery cage 202, an example of which is shown in FIG. 2 as the slanted portion 204. It should be appreciated, however, that the tactile sensor 210a may be placed at any suitable location conducive to detecting eggs.

In some embodiments, an egg-counting sensor may be a remote sensor, such as sensor 210b. The remote sensor 210b may be configured to remotely detect or count an egg, such as egg 208b, using any suitable remote detection technique, such as optical, infrared, etc.

In some embodiments, an egg-counting sensor may be a weight detecting sensor, such as sensor 210c. In the example of FIG. 2, weight detecting sensor 210c is located below a portion of conveyer belt 206, though it should be appreciated that embodiments are not limited to a particular location of weight detecting sensors. Further, weight-detection sensor 210c need not necessarily directly measure a weight, and may, in some embodiments, infer a weight based on other detected information

Sensors may be powered by any suitable powering technique, including but not limited to, battery, photovoltaic, vibrational, temperature gradient, electromagnetic, etc. As another example, if a sensor is electronically attached to moving object, such as an actuated mechanism, a hen, or a human worker, then the sensor may be powered by motion.

Regardless of the exact nature of the egg-counting sensors 210a-210c, the egg-counting sensors may detect any suitable amount of information to determine an egg count. For example, the counting may be exact or sampled. In some embodiments, an egg-counting sensor may attempt to collect exact information, such as counting every egg from every hen (or every group of hens). In some embodiments, a sensor may collect sampled information, such as by only count eggs from a sampled group of hens, some of the time. The amount of information collected by each sensor may determine how many sensors are used, the complexity of each sensor, and the resulting accuracy of estimation/prediction of compliance based on the egg count.

In some embodiments, in addition or as an alternative to egg-counting sensors, other types of sensors may be used to provide data related to the egg laying hens. Such data may be used by itself to determine a health status of the hens and/or quality of eggs, or may be used in addition to egg count data to provide redundancy and improve accuracy.

As non-limiting examples, other types of sensors may detect information related to hens (vital signs, hen sounds, motion, etc.) or related to the environment around the hens (temperature, light, sound, etc.). Additionally or alternatively, sensors may be configured to detect behavior of humans. The monitored behavior of humans may include, for example, time spent on certain tasks, completion of tasks, and/or efficiency in completing tasks, related to monitoring egg laying and/or health of hens. Such human behavioral data may be correlated with other types of data collected within the system 200 and analyzed in aggregate by the server 102 to determine an overall compliance status.

In the example of FIG. 2, sensor 212a may be configured to collect the data directly from a hen in the battery cage 202. As another example, ambient sensor 212b may be configured to collect data from the environment. For example, sensor 212b may be configured to collect temperature, light conditions, or any other appropriate type of data related to egg laying conditions of hens.

In some embodiments, in addition to collecting data, sensors may perform processing on data collected and/or instructions received. For example, in some embodiments, sensors may perform compression on data that is collected, using techniques in compressive sensing. Such compression may enable a more compact representation of the collected data to be transmitted, thus conserving communication resources. It should be appreciated, though, that embodiments are not limited to compressive sensing, and that data may be transmitted from sensors to the server 102 in the same form in which they are sensed.

Regardless of the exact function, number, and location of sensors in system 200, one or more sensors may collect data relevant to egg laying and compliance of the egg farm, and transmit that collected data to one or more computing devices, such as the server 102. Sensors may transmit data according to any suitable schedule. For example, sensors may transmit data whenever new information detected, or at periodic intervals. To save power, sensors may transmit in response to query/poll. In some embodiments, sensors may transmit egg-count information (and/or other related information) to a receiver, either directly or relayed via other devices, which may themselves be sensors.

The transmission from sensors may be in any suitable format. As non-limiting examples, binary information may be transmitted, indicating compliance or noncompliance. In some embodiments, more additional information or non-binary information may be transmitted to indicate more details, such as a location of non-compliance, or other suitable information. It should be appreciated, however, that embodiments are not limited to any particular format or representation of data, as the information collected by sensors may be transmitted in any suitable representation. For example, in some embodiments, a sensor may transmit information in multiple stages, for example, first transmitting simpler (e.g., binary) information, then transmitting more detailed information, either upon request or on its own.

Further, any suitable signaling technique may be used when transmitting data from the sensors. For example, a signaling technique may be based on amplitude modulation or frequency/phase modulation, etc., to convey the information. Regardless of the exact nature of a signaling technique used, data may be transmitted from one or more sensors to one or more receivers, such as receivers 214a and 214b. Such receivers may be, for example, wireless access points, routers, other sensors, or any other suitable computing device that is able to receive and transmit information.

In some embodiments, transmissions from multiple sensors and/or other computing devices to a receiver may be coordinated with an access scheme. Examples include, but are not limited to statistical multiplexing (e.g., carrier sense multiple access (CSMA)) and orthogonal multiplexing (each sensor may have a unique signal, and the system may map the signal to a known location). Some examples of orthogonal multiplexing include: frequency division multiplexing (FDM), in which every sensor is assigned a unique frequency; time division multiplexing (TDM) in which every sensor is assigned a unique time slot; code division multiplexing (CDM), in which every sensor is assigned a unique code; and space division multiplexing (SDM), in which multiple antennas with beam-forming are used. It should be appreciated, however, that any suitable transmission and modulation technique may be used in the environment 200 to coordinate transmission from multiple sensors and/or relays, as embodiments are not limited in this regard.

It should be appreciated that the system is not limited to use in caged systems, as it may also be used in free-range egg farms. For example, in free-range farms with nest boxes, the system may count a number of eggs in nests to estimate an actual total egg count. In some embodiments, counting may be performed by image processing of different areas of the farm, to detect egg-shaped objects. Regardless of the exact nature of the egg farm and the technique of detecting eggs, various types of sensors may be configured to count eggs and the system may determine, based at least on the counted eggs, a compliance status of the egg farm.

In some embodiments, results of the analysis by server 102 may be displayed on a device 216, which may be a mobile device operated by a user. As non-limiting examples, the device 216 may present alerts regarding compliance or potential non-compliance, or may present instructions and/or recommendations based on analyzed data. The instructions and/or recommendations may be based on a set of protocols established by an entity, such as the egg farm, a governmental body, or an industry organization. The instructions and/or recommendations may relate to operation of machines, handling of eggs, recording or reporting certain actions, or any other task related to managing the egg laying and compliance of the egg farm. Additionally or alternatively, the mobile device 216 may include a sensor that is configured to detect data from a human, using for example, microphones and/or other sensors.

In such scenarios, the rules engine 204 may recognize an inconsistency between various types of collected data, and may generate an alert indicating a potentially unhealthy hen or hens. Such an alert may be used, for example, by an egg farm to check the indicated hens, or to check eggs produced by the hens As such, the server 102 may be able to analyze the collected data to detect potential sources of non-compliance, even when other sources of data, whether collected by sensors or entered by humans, do not indicate any problems. The rules engine 104 may also be configured to detect lack of collected data, whether due to malfunctioning sensors or due to human error and/or fraud, and to generate alerts based on the lack of collected data. Algorithm/rules can aggregate these different types of information to infer health of hens.

In some embodiments, such cross-correlation of different types of data may also reduce occurrences of false alarms, in which healthy hens are mistakenly detected to be unhealthy. Such false alarms may degrade efficiency of an egg farm, by causing the egg farm to implement various actions to check on the status of hens and/or eggs, which may otherwise not be necessary. For example, in some embodiments, this may reduce the need to send humans into potentially unsafe conditions within a large egg farm to check potential events of non-compliance.

In some embodiments, the system 200 may be able to provide such real-time compliance monitoring, using egg count data and/or other types of data related to egg laying by hens. Such a system may enable not only faster response and locating and handling non-compliant hens and/or eggs, but may also enable proactive actions to mitigate conditions that may potentially cause non-compliance. In some embodiments, this may be achieved by cross-correlating data that has been collected from different types of sensors, and detecting any inconsistencies or anomalies that may indicate non-compliance with a set of provided standards. Such a preventative system, may, in some embodiments, drastically improve the efficiency and safety of an egg farm, and particularly those that manage hundreds of thousands of hens distributed over a large egg farm.

The system 200, in some embodiments, may also have the ability to adaptively learn and predict the behavior of egg laying hens to facilitate proactive alerts and/or minimize the occurrence of false alarms. Such learning and predictive analysis may be enabled, in some embodiments, by any suitable learning technique, such as machine learning algorithms, neural networks, simulations, or other suitable techniques, as embodiments are not limited in this regard. Regardless of the exact nature of the analysis implemented by the rules engine 104, the analysis may be configured to operate on a wide variety of data collected by different sensors, and in some embodiments, stored in the data store 106. The data store 106 may comprise data that is collected from sensors, and also may comprise standards, regulations, and specifications that should be followed by one or more entities and the distributed work environment.

FIG. 3 illustrates one example of a data store 300 that stores various types of data and standards. It should be appreciated, however, that embodiments are not limited to storing these particular types of data, as more or less types of data and standards may be stored suitable to the environment in which the system operates.

Although embodiments are not limited to the exact nature of data stored in the data store 300, in some embodiments, the data store 300 may store at least data related to individual hens, a cage of hens, or a region of hens. For example, hen data may be stored in a hen database 302, cage data may be stored in cage database 304, had data for a particular region of the egg farm may be stored in a region database 306. In some embodiments, the data store 300 may also store one or more specifications and/or standards related to analyzing data that has been collected by the sensors.

In some embodiments, the human database 302 may comprises data representing individual hens. Hen database 302 may include one or more entries for hens, two of which are shown in FIG. 3, Hen 1 and Hen 2. It should be appreciated, however, that embodiments are not limited to any particular number of hens for which data is stored. In some embodiments, data stored for a hen may include historical data, such as egg counts over a past period of time. In FIG. 3, Hen 1's data 308 is shown, along with health data 312 and environmental 314, which may indicate one or more environmental conditions related to Hen 1.

In some embodiments, the health data 312 and environmental data 314 may have been collected from one or more biological and/or environmental sensors. As a non-limiting example, health data 312 may be collected by sensors that are either attached to the hens or remote from the hens. In some embodiments, the health data 312 may have been collected off-line, by human measurements of the hen. Regardless of the exact nature of the health data 312, one or more historical health data for Hen 1 may be stored in the hen database 302.

In some embodiments, the data store 300 may comprise a cage database 304. In the example of FIG. 3, data for two cages are shown, though embodiments are not limited to a particular number of cages. In some embodiments, Cage 1 data 316 may comprise egg count data 318 that relates to a number of eggs produced by hens in Cage 1. Such data may be collected by sensors that detect various metrics associated with eggs produced from Cage 1, as described in relation to FIG. 2. The Cage 1 data 316 may also comprise, in some embodiments, health data 320, which may represent health conditions, either measured in real-time or off-line, of hens in Cage 1. In some embodiments, Cage 1 data may include environmental data 322, representing collected data related to one or more ambient conditions of Cage 1. The health data 320 and/or the environmental data 322 may be used by a rules engine (e.g. rules engine 104 in FIG. 2) in addition or as an alternative to egg count data 318 to determine a health status of hens in Cage 1.

Though, it should be appreciated that other types of data related to cages may be stored in the cage database 304, as embodiments are not limited to a particular type or number of data collected and analyzed.

In some embodiments, data store 300 may comprise a regional database 306 that stores data for hens in a particular region, which may be inside or outside, of an egg farm. As non-limiting examples, to such regions are shown in FIG. 3, though it should be appreciated that embodiments are not limited to a particular number of regions, if any, that are monitored and analyzed. In the example of FIG. 3, region one data 324 comprises various types of data related to hens in that region. For example, there may be egg count data 326, health data 328, and environmental data 330, all of which or some of which may be directly or indirectly related to the hens in region one.

In some embodiments, the data store 300 may comprise a standards database 332, which may store data related to various standards, such as regulations, rules, and/or specifications applicable to the egg farm. As non-limiting examples, the standards database 332 may comprise governmental regulations 334. In some embodiments, standards database 322 may comprise industry standards 336, which may represent protocols and/or standards established by, for example, industry organizations or trade groups. In some embodiments, the standards database 332 may comprise company specifications 338, which may represent company specific protocols and/or rules established by the egg farm, related to egg laying and health of hens.

It should be appreciated, however, that the standards database 332 is not limited to these specific types of standards, and that more or less standards may be stored in the data store 300. For example, in some embodiments, there may be no applicable governmental regulations 334 and/or no applicable industry standards 336, in which case the standards database 332 may only comprise company specifications 338.

FIGS. 4 and 5 are flow charts that describe examples of processing that may be performed by a server (e.g., server 102 in FIG. 2), or any other computing device that analyzes data collected from sensors. The various steps involved in FIGS. 4 and 5 may be performed in real time as data is collected and received from the sensors, or may be performed in an offline manner with data already available for analysis. Regardless of the exact times and manner in which the steps of FIGS. 4 and 5 are implemented, the processes described in these examples may be used to analyze and aggregate data collected from sensors, estimate a compliance status. The server 102 may also predict a future compliance status, detect non-compliance or potential non-compliance, and/or generate alerts instructions based on the analysis.

Based on sensor data, in some embodiments, it may be desirable to improve sensitivity (detect non-compliance) while minimizing false alarms (reduce manpower to inspect hens/eggs that are already compliant). To achieve a desired tradeoff, the rules engine may be tuned to analyze one or more types of data collected by one or more types of sensors, to formulate an aggregate opinion of whether and where to inspect for non-compliance. The rules engine may perform its analysis based on historical data or statistical averages.

For example, the rules engine may use historical data collected from sensors to analyze and/or predict potential non-compliance. For example, the rules engine may analyze a past window of data collected from one or more sensors, or sampled data from the past history, or any suitable set of past historical data. The data may be any type of data collected by any type of sensor, such as egg count sensors, human behavioral sensors, environmental sensors, etc. In some embodiments, the rules engine may utilize machine learning algorithms to predict potential non-compliance, such as potential failure by a human worker to inspect certain hens/eggs, or to perform other actions related to compliance monitoring. The rules engine may generate an alert if there is a deviation from any acceptable standard.

In some embodiments, the rules engine may use statistical parameters such as mean or variance, compare collected data to those statistical parameters, and generate an alert if the data is outside of a standard deviation of the mean. The statistical data may be related to a number of eggs, or may be related to non-egg-count data such as human behavioral data, environmental data, hen behavioral data, etc. Other statistical-based methods may be used for detecting deviation from normal behavior, such as those based on a priori statistical (Bayesian) models, though it should be appreciated that embodiments are not necessarily limited to using statistical models, or even statistical data at all.

Based on the analysis and/or prediction, the rules engine may generate alerts and/or instructions to a user regarding at least one potential location of non-compliance. For example, if an estimated/predicted egg count is either below or above established thresholds, then the rules engine may indicate an alert/instructions. The thresholds may be based on various factors, and may be configured to achieve a desired balance between false alarms and detection sensitivity.

FIG. 4 is a flowchart of an example of a process 400 that may be implemented by a server (e.g., server 102 in FIGS. 1 and 2). Process 400 may begin in block 402 with the server accessing data and/or standards from a data store (e.g., data store 300 in FIG. 3). Though, it should be appreciated that data and/or standards may be accessed from any suitable data store, which may be local to the server or at a remote location, for example, connected to a network accessible by the server. In some embodiments, the data and/or standards that are accessed in block 402 may be a subset of the data and standards stored in a data store. In scenarios in which there is a large amount of collected data and/or standards, such selective accessing of information from the data store may enable more efficient and faster analysis. For example, different types of data may contribute different amounts of utility to an analysis of compliance with one or more standards. The rules engine may be able to determine, based on prior measurements and analysis, which types of data yields the highest expected information gain, and may access only those data.

In some embodiments, sensors may be configured to collect or not collect certain types of data. For example, some sensors may be configured not to collect data in order to conserve energy and/or communication resources, based on a determination that data collected by those sensors would yield smaller expected information gain than other sensors. Regardless of the exact nature in which data is accessed and/or available, the system may recognize that only a subset of data that could potentially be collected by the sensors may be sufficient to yield a desired level of estimation and/or prediction accuracy, and that data collected by other sensors may yield diminishing returns.

Based on the data and standards that have been accessed from the data store, in block 404, the rules engine may be applied to the collected data and prescribed rules, to determine non-compliance in the egg farm. In block 406, if it is determined that the analyzed data indicates non-compliance, then, in block 408, the system may generate one or more alerts. For example, such alerts may be indicated on remote reporting devices (e.g., reporting device 216 in FIG. 2), or on the sensors, or on any suitable computing device. Such alerts may include an indication of location(s) or other information related to the non-compliance.

Additionally or alternatively, the system may, in block 410, issue specific instructions and/or recommendations regarding handling of non-compliant hens and/or eggs, for example, on a reporting device (e.g., reporting device 216 in FIG. 2). For example, block 410 may involve issuing instructions to adjust or modify human tasks and/or machine operations to handle non-compliance, though embodiments are not limited in this regard.

As another example, if a detected egg count is above a specified threshold, then the rules engine may, in some embodiments, determine more detailed egg count information to determine a particular area of the egg farm that may account for the high egg count. For example, the rules engine may issue instructions to check a particular storage facility's data log to determine whether foreign eggs may have been introduced into the egg farm at any point within a period of time before the over-count of eggs was detect.

In some embodiments, even if the rules engine has not detected any non-compliance based on the collected data, then the system may still issue any necessary instructions or recommendations in block 410 after compliance detection in block 406, without generating any alerts.

After appropriate determination and issuance of instructions have been performed, in some embodiments, in block 412, the data store may be updated with results of the analysis and/or the issued instructions. The data store may also be updated with revised standards and/or predicted data based on results of the analysis.

It should be appreciated that issuing instructions in block 410 and updating the data store in block 412 are optional, and in some embodiments, an alert and location of pest infestation may be generated, in case of detected or predicted non-compliance, without any specific instructions or updates of the data store.

FIG. 5 is a flowchart of an exemplary process 500 of processing by a rules engine. For example, in some embodiments, process 500 may represent details of the processing performed by the rules engine (e.g. block 404 of FIG. 4) to analyze the collected data. The process 500 performed by a rules engine may apply any combination of suitable techniques to analyze the different types of data collected by sensors, to detect non-compliance, predict potential future non-compliance, and/or determine the appropriate instructions based on the analysis. Although process 500 in FIG. 5 illustrates one possible sequence of processing that may be performed by the rules engine, it should be appreciated that embodiments are not limited to any particular sequence or nature of processing and, in general, the rules engine may apply any suitable processing to the collected data to determine non-compliance.

In block 502, the rules engine may correlate various types of collected data, which, in some embodiments, may comprise the different types data described above in relation to FIG. 3. Though, it should be appreciated that in some embodiments, more or less data may be used. In some embodiments, if the data was compressed by the sensors prior to communication, then in step 502, the received data may be decompressed before performing correlation. Additionally or alternatively, decompression of any compressed data may be performed in block 402 of FIG. 4.

In some embodiments, correlation of the data may comprise performing data fusion and/or data mining to extract information that may be relevant from within the data. For example, in some embodiments, data fusion may comprise processing the data collected by the sensors to create a more compact representation of information relevant to determine non-compliance. In some embodiments, block 502 may, additionally or alternatively, apply data mining algorithms, which may comprise detecting any anomalies, patterns, classifications, and/or other associations between the different types of data collected. In some embodiments, if the collected data is voluminous, then the data fusion and/or data mining algorithm may enable representing the voluminous data in a more compact manner. Though, it should be appreciated that block 502 is not necessarily limited to generating compact representations of the collected data, as correlation of data may comprise any suitable processing to determine correlations between the data collected by the different types of sensors.

If the data that is correlated in block 502 is insufficient to determine non-compliance, then in block 504, it may be determined that more data is necessary. Then, in block 506, more data may be obtained, either from the data store or from the sensors, and the updated data may be used to perform the correlation in block 502. In some embodiments, the updated data in block 506 may simply be accessed by querying the data store for the desired data, and in some embodiments, a communication may be sent to one or more sensors to collect and transmit more or different types of data. Regardless of how this updated data is obtained, the processing in blocks 502 and 504 may be repeated until it is determined that a sufficient amount of data is available.

Then in block 508, in some embodiments, the rules engine may generate an estimate or prediction of non-compliance, based on the measured data and any correlation performed in block 502. The estimation and/or prediction of non-compliance may be achieved by any suitable technique. For example, the rules engine may apply one or more machine learning algorithms. As non-limiting examples, machine learning algorithms may comprise neural networks, linear/non-linear optimizations, Bayesian learning networks, or other suitable techniques that can analyze data measured from a system to predict a future parameter status of the system.

For example, if a Kalman filter is used, then the predictive step of the Kalman filtering processing may be used to generate an estimate of a current compliance status, or a prediction of a future compliance status, based on past estimates of compliance status and measurements from the sensors. As a non-limiting example, a compliance status for a particular hen or group of hens may be specified as a binary 1 or 0, indicating either healthy or unhealthy hens. Alternatively, non-binary results may be generated, indicating various levels of certainty that a hen is healthy.

In some embodiments, the rules engine may be able to generate an estimate or prediction of the binary compliance status on past measurements and estimates of compliance status. In addition, in some embodiments, a confidence score may be generated for the prediction, indicating a level of confidence in the prediction. For example, the confidence score may be a maximum a posteriori probability (MAP), though embodiments are not limited in the use or nature of a confidence score.

In some embodiments, if predictive processing is used by the rules engine, then it may enable proactive monitoring and management of non-compliance. As such, even if a current estimate by the rules engine, other determinations by other means, do not indicate existing non-compliance, the rules engine may be able to use predictive analysis to proactively determine whether certain areas of an egg farm may potentially be likely for non-compliance. Regardless of the exact nature of estimation and/or prediction performed in block 508, any suitable machine learning algorithm may be used, whether supervised with actual measurements from hens/eggs, or unsupervised with only data collected from sensors external to the hens/eggs, to generates estimates and/or predictions of non-compliance.

In block 508, the determined estimates and/or predictions of non-compliance may be correlated with a prescribed set of rules to determine whether action should be taken. For example, a standard, specification or instruction may require that three consecutive non-compliance indications (e.g., a binary indicator of 0) for a hen or group of hens requires action to be taken. As another example, if confidence scores are used, then determination of compliance may be based on a particular threshold of confidence score above which a decision is to be made. The rules (e.g., from standards database 312 in FIG. 3) applied in block 508 may be any suitable set of rules provided by governmental agencies, industry trade groups, or a specific company.

In some embodiments, based on the analysis of the data collected by the sensors, in block 510, the rules engine may determine appropriate actions to be taken. For example, actions may involve manually checking a cage of hens or batch of eggs, adjusting a machine setting on a sensor, and/or double-checking environmental or biological data detected to be anomalous. In some embodiments, such actions may be performed in response to a detected non-compliance and/or potential future non-compliance, or may be performed even when no non-compliance is detected/predicted.

In some embodiments, block 512 may additionally or alternatively comprise modifying or reconfiguring sensors, to collect more, less, or different types of data. For example, the rules engine may determine, based on the results of the analysis, which collected data are most useful in determining non-compliance in a particular group of hens or batch of eggs. Based on such determination, the system may reconfigure the sensors such that only those sensors whose measurements yields the highest expected information gain perform data measurement and communication. In some embodiments, this may enable improved usage of resource constrained sensors, and/or may streamline the processing by the rules engine by correlating only the data that is most useful in block 502. In addition, or as an alternative, to resource management, sensor reconfiguration may be performed to improve the accuracy and reliability of estimation and/or prediction of non-compliance. Such sensory configuration may comprise collecting more data, or different types of data at certain critical control points, or other parts of the egg farm.

It should be appreciated, however, that the system need not necessarily be automatically reconfigured, and may determine existing and/or potential non-compliance without also determining modifications to sensors, human work tasks, or other parts of the system.

Such an automated compliance monitoring system may enable automating the detection, counting, and localization of non-compliant hens and/or eggs, and reduce the reliance on potentially erroneous and/or fraudulent human inspection.

FIG. 6 illustrates an example of a suitable computing system environment 600 on which the invention may be implemented. This computing system may be representative of a central server (e.g., server 102 in FIG. 1), a sensor (e.g., sensors 110a, 110b, 112 in FIG. 1), or a reporting device (e.g., reporting devices 116a-116c in FIG. 1). However, it should be appreciated that the computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the exemplary operating environment 600.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 6, an exemplary system for implementing the invention includes a general purpose computing device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through an non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through a output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on memory device 681. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A system for monitoring an egg farm, the system comprising:
an egg detection device configured to detect eggs;
a transmitter configured to transmit egg count information indicating a number of eggs detected by the egg detection device; and
a computing device configured to execute at least one algorithm that analyzes the egg count information and determines a compliance status.

2. The system of claim 1, wherein the compliance status indicates a health status of hens or a quality status of eggs.

3. The system of claim 1, wherein the computing device determines the compliance status by determining whether the egg count information indicates a number of eggs within a predetermined range.

4. The system of claim 2, wherein if the egg count information indicates a number of eggs below the predetermined range, the system further determines at least one hen associated with the egg count information.

5. The system of claim 2, wherein the predetermined range corresponds to either an individual hen, a group of hens, or a region of the egg farm.

6. The system of claim 1, further comprising a data store configured to store data comprising the egg count information and at least one rule.

7. The system of claim 6, wherein the at least one rule comprises at least one of a governmental regulation, an industry standard, or a company specification.

8. The system of claim 6, wherein the at least one rule comprises an instruction or a task for a human worker.

9. The system of claim 6, wherein the computing device is further configured to determine a location of non-compliance by accessing the data store to determine one of a plurality of predetermined geographic regions.

10. The system of claim 1, further comprising a plurality of receivers, and wherein the computing device determines a location of non-compliance based, at least in part, on signals received from the plurality of receivers.

11. The system of claim 1, further comprising a secondary sensor configured to collect at least one of human behavioral data, environmental data, biological data, or machine data.

12. The system of claim 1, wherein the egg detection device is configured to detect eggs using tactile sensing.

13. The system of claim 1, wherein the egg detection device is configured to detect eggs using remote motion sensing.

14. The system of claim 1, wherein the egg detection device is configured to detect eggs using weight sensing.

15. The system of claim 1, wherein:
the egg detection device comprises an image capturing device; and
the computing device is further configured to perform image processing on the captured images, wherein the image processing comprises recognizing an image pattern corresponding to at least one egg.

16. The system of claim 15, wherein the image capturing device comprises an infrared-spectrum sensor.

17. The system of claim 15, wherein the image capturing device comprises a visible-spectrum sensor.

18. The system of claim 17, wherein the optical image capturing device is further configured to coordinate the timing of image capturing with at least one illumination device.

19. The system of claim 1, wherein the egg detection device is configured to be periodically polled for updates.

20. The system of claim 1, further comprising a display device configured to present a display indicating the compliance status.

21. A method of monitoring an egg farm, the method comprising:
detecting at least one egg using an egg detection device;
transmitting egg count information indicating a number of eggs detected by the egg detection device; and
using at least one processor to execute at least one algorithm that analyzes the egg count information and to determine a compliance status.

22. The method of claim 21, wherein the compliance status indicates a health status of hens or a quality status of eggs.

23. The method of claim 21, wherein determining the compliance status comprises determining whether the egg count information indicates a number of eggs within a predetermined range.

24. The method of claim 23, further comprising determining at least one hen associated with the egg count information if the egg count information indicates a number of eggs below the predetermined range.

25. The method of claim 23, wherein the predetermined range corresponds to either an individual hen, a group of hens, or a region of the egg farm.

26. The method of claim 21, further comprising storing, in a data store, data comprising the egg count information and at least one rule.

27. The method of claim 26, wherein the at least one rule comprises at least one of a governmental regulation, an industry standard, or a company specification.

28. The method of claim 26, wherein the at least one rule comprises an instruction or a task for a human worker.

29. The method of claim 26, further comprising determining a location of non-compliance by accessing a data store to determine one of a plurality of predetermined geographic regions.

30. The method of claim 21, further comprising determining a location of non-compliance based, at least in part, on signals received from a plurality of receivers.

31. The method of claim 21, further comprising detecting secondary data comprising at least one of human behavioral data, environmental data, biological data, or machine data.

32. The method of claim 21, wherein detecting at least one egg comprises tactile sensing.

33. The method of claim 21, wherein detecting at least one egg comprises remote motion sensing.

34. The method of claim 21, wherein detecting at least one egg comprises weight sensing.

35. The method of claim 21, further comprising using the at least one processor to perform image processing on at least one image, the image processing comprising recognizing an image pattern corresponding to at least one egg.

36. The method of claim 35, wherein the at least one image comprises an infrared-spectrum image.

37. The method of claim 35, wherein the at least one image comprises a visible-spectrum image.

38. The method of claim 37, further comprising coordinating a timing of capturing the at least one image with a timing of at least one illumination device.

39. The method of claim 21, further comprising transmitting periodic polls for updates on egg count information.

40. The method of claim 21, further comprising presenting a display indicating the compliance status.

41. At least one computer-readable medium having stored thereon computer-readable program instructions which, when executed by at least one processor, perform acts of:
detecting at least one egg using an egg detection device;
transmitting egg count information indicating a number of eggs detected by the egg detection device; and
analyzing the egg count information to determine a compliance status.

42. The at least one computer-readable medium of claim 41, wherein the compliance status indicates a health status of hens or a quality status of eggs.

43. The at least one computer-readable medium of claim 41, wherein determining the compliance status comprises determining whether the egg count information indicates a number of eggs within a predetermined range.

44. The at least one computer-readable medium of claim 43, further comprising determining at least one hen associated with the egg count information if the egg count information indicates a number of eggs below the predetermined range.

45. The at least one computer-readable medium of claim 43, wherein the predetermined range corresponds to either an individual hen, a group of hens, or a region of the egg farm.

46. The at least one computer-readable medium of claim 41, further comprising storing, in a data store, data comprising the egg count information and at least one rule.

47. The at least one computer-readable medium of claim 46, wherein the at least one rule comprises at least one of a governmental regulation, an industry standard, or a company specification.

48. The at least one computer-readable medium of claim 46, wherein the at least one rule comprises an instruction or a task for a human worker.

49. The at least one computer-readable medium of claim 46, further comprising determining a location of non-compliance by accessing a data store to determine one of a plurality of predetermined geographic regions.

50. The at least one computer-readable medium of claim 41, further comprising determining a location of non-compliance based, at least in part, on signals received from a plurality of receivers.

51. The at least one computer-readable medium of claim 41, further comprising detecting secondary data comprising at least one of human behavioral data, environmental data, biological data, or machine data.

52. The at least one computer-readable medium of claim 41, wherein detecting at least one egg comprises tactile sensing.

53. The at least one computer-readable medium of claim 41, wherein detecting at least one egg comprises remote motion sensing.

54. The at least one computer-readable medium of claim 41, wherein detecting at least one egg comprises weight sensing.

55. The at least one computer-readable medium of claim 41, further comprising using the at least one processor to perform image processing on at least one image, the image processing comprising recognizing an image pattern corresponding to at least one egg.

56. The at least one computer-readable medium of claim 55, wherein the at least one image comprises an infrared-spectrum image.

57. The at least one computer-readable medium of claim 55, wherein the at least one image comprises a visible-spectrum image.

58. The at least one computer-readable medium of claim 57, further comprising coordinating a timing of capturing the at least one image with a timing of at least one illumination device.

59. The at least one computer-readable medium of claim 41, further comprising transmitting periodic polls for updates on egg count information.

60. The at least one computer-readable medium of claim 41, further comprising presenting a display indicating the compliance status.

61. A system configured to monitor, manage, and instrument compliance in a distributed work environment, the system comprising:
at least one input configured to receive data comprising egg count information and secondary information related to one or more of
a. behavior of one or more persons responsible for taking action in the distributed work environment,
b. biological or environmental parameters associated with the distributed work environment,
c. operational conditions and/or events,
d. apparatus usage and/or condition,
e. at least one standard and degree of compliance therewith, or
f. product production and/or delivery logistics;
a data store configured to store the data;
at least one processor configured to execute stored program instructions to process at least part of the data;
determine, based on the processing of at least part of the data, a compliance status.

62. The system of claim 61, wherein the compliance status indicates a health status of hens or a quality status of eggs.

63. The system of claim 61, wherein determining the compliance status comprises determining whether the egg count information indicates a number of eggs within a predetermined range.

64. The system of claim 63, further comprising determining at least one hen associated with the egg count information if the egg count information indicates a number of eggs below the predetermined range.

65. The system of claim 63, wherein the predetermined range corresponds to either an individual hen, a group of hens, or a region of the egg farm.

66. The system of claim 61, wherein the at least one input is further configured to receive the data using at least one sensor.

67. The system of claim 66, wherein the at least one sensor is configured to detect a human behavior comprising at least one of a speech, a motion, a location, or an interaction.

68. The system of claim 66, wherein the at least one sensor is dynamically re-configurable based, at least in part, on the processing of the at least part of the data.

69. The system of claim 61, wherein the at least one standard comprises at least one of a governmental regulation, an industry standard, or a company specification.

70. The system of claim 62, wherein the compliance status further indicates at least one of a behavioral status, a biological status, an operational status, a machine status, or a logistical status.

71. The system of claim 61, wherein determining the compliance status comprises estimating a current and/or future state of the compliance status, based on the processing of the at least part of the data.

72. The system of claim 61, wherein determining the compliance status comprises determining whether at least one requirement has been satisfied by an entity involved in the distributed work environment.

73. The system of claim 72, wherein determining whether at least one requirement has been satisfied by an entity comprises comparing the data with a predetermined pattern, to determine an indication of a fraudulent and/or erroneous activity.

74. The system of claim 61, further comprising an output device configured to present an output result indicating the compliance status.

75. The system of claim 74, wherein the output result further comprises at least one instruction.
